(19) United States
(12) Patent Application Publication
(10) Pub. No.: US 2011/0214163 A1
(43) Pub. Date: Sep. 1, 2011

(54) AUTOMATED ANALYSIS OF COOKIES

(75) Inventors: Nathan Miottel Smith, New York, NY (US); Wil Hutchins, Calgary (CA)

(73) Assignee: Jumpstart Digital Marketing, Inc. (d.b.a. Jumpstart Automotive Media)

(21) Appl. No.: 12/849,690

(22) Filed: Aug. 3, 2010

Related U.S. Application Data
(60) Provisional application No. 61/308,767, filed on Feb. 26, 2010.

(51) Int. Cl. G06F 21/00

(52) U.S. Cl. 726/4

(57) ABSTRACT

Techniques and tools relate to analysis of cookies. For example, techniques and tools are described for determining whether cookies stored on a computer in response to a particular event (e.g., the rendering of an advertisement in a browser) are authorized. In one implementation, a cookie analysis system includes a browsing simulator having a web browser and a virtual graphical environment. The browsing simulator renders web pages (e.g., automatically), including ad creative objects (e.g., objects that represent images, graphical animations, video clips, etc.) corresponding to advertisements in the web pages. The cookie analysis system creates test files for the ad creative objects. The cookie analysis system identifies and analyzes cookies (e.g., HTTP cookies, or other objects such as local shared objects) that are set in response to the rendering of ad creative objects.

### CROSS REFERENCE TO RELATED APPLICATIONS

This application claims the benefit of U.S. Provisional Patent Application No. 61/308,767, filed on Feb. 26, 2010, entitled “AUTOMATED ANALYSIS OF COOKIES,” which is incorporated herein by reference.

### FIELD

Techniques and tools described herein relate to analysis of cookies, and more particularly to detecting and analyzing unauthorized cookies (e.g., unauthorized HTTP cookies) stored on client computers in response to particular events (e.g., rendering of advertisements on a web page).

### BACKGROUND

Cookies are pieces of information stored on computers that provide information to other computers on a network. Unlike other information that a user of a computer provides manually (such as information entered by a user in a form on a web site), cookies are designed to provide information automatically, often without the user's knowledge. Information provided by cookies can take many forms. Some common types of information provided by cookies are user identity information (e.g., a user ID number), browser information (e.g., a browser type and version number), session or state information that allows websites to “remember” aspects of a particular browsing session (e.g., user preferences, account login information, or the contents of an online “shopping cart”), and user behavior information (e.g., a record of which websites a user has visited).

In a typical web browsing scenario, a user navigates to a website at a particular Uniform Resource Locator (URL) (e.g. using the Hypertext Transfer Protocol (HTTP)) via a web browser. A server provides source code (e.g., HTML source code) and/or other data to the web browser, which renders the source code and/or other data as a web page. In addition, the server may store a cookie on the user's computer. For example, a web server can store a cookie on a client computer when a user visits a website for the first time. As long as that cookie remains on the computer, the server can find the cookie and use the information stored in the cookie to provide the user with custom-tailored information, or for other purposes. For example, a website that a user has visited before can use a customized greeting to welcome the user back to the website. Cookies also can be stored on client computers by third parties (i.e., by entities other than those that actually control the websites visited by a user). Such cookies are referred to as third-party cookies. Third parties can include advertisers and advertising consultants responsible for providing advertisements on web pages.

Using the World Wide Web and other protocols, content providers (or “publishers”) often work with advertisers to help them reach more customers. For example, publishers provide content (e.g., news articles, images, video, audio, personalized content such as a social networking pages, etc.) to a user via a web page along with advertisements. Advertisements are often presented as images or animations, e.g., in the form of a banner ad that runs above, below, or alongside content on the page being visited by the user. Such an image or animation can be referred to as an “ad creative.” Besides images or animations, ad creatives also can take other forms, such as plain text or hyperlinks.

In a typical ad-supported website scenario, when a user visits a page, an ad server controlled by the publisher provides an advertisement on the page. To do this, the ad server sends a page identifier to an advertiser's server. The page identifier identifies the page (in this case, the page being visited by the user) that originated the ad call. In response, the advertiser sends an appropriate ad creative to the ad server, which then downloads the ad creative to the user's computer. In some cases, the advertiser that provides the ad creative may be the company that actually sells the advertised product, but often the ad creative comes from an advertising consultant hired by the seller to create the advertisement on its behalf.

By placing cookies on computers of users that visit their websites, publishers are able to acquire valuable information about user behavior. Publishers can then sell this information to advertisers, who can use the information to learn more about their customers. Unauthorized cookies can cause publishers to lose control of (and, potentially, lose revenue from) valuable user behavior information.

Whatever the benefits of previous techniques, they do not have the advantages of the techniques and tools presented below.

### SUMMARY

Techniques and tools are described that relate to the analysis of cookies on a computer. For example, techniques and tools are described for determining whether cookies that have been stored on a computer in response to a particular event (e.g., the rendering of an advertisement in a browser) are authorized. In one implementation, a cookie analysis system includes a browsing simulator having a virtual graphical environment that renders web pages (e.g., automatically, without displaying the web pages) and/or objects in web pages. For example, the cookie analysis system creates a test file for each one of a set of several ad creatives (e.g., an image, graphical animation, video clip, etc.). The ad creative is typically represented as an ad creative object, such as a programming object. The cookie analysis system identifies cookies (e.g., HTTP cookies or other objects such as local shared objects) that are stored on the computer in response to the rendering of a particular ad creative object. The cookie analysis system can be used to determine, for example, whether cookies generated in response to the rendering of ad creative objects are unauthorized or potentially unauthorized. For example, the cookie analysis system can extract domain information from cookies, and compare the domain information with a list of authorized, unauthorized, or potentially unauthorized domains. Data obtained by the cookie analysis system can be used in further processing. For example, cookie information can be presented in a report showing details of unauthorized cookies.

The foregoing and other objects, features, and advantages of the invention will become more apparent from the following detailed description, which proceeds with reference to the accompanying figures.

### BRIEF DESCRIPTION OF THE DRAWINGS

FIG. 1 is a system diagram showing an arrangement in which a client computer makes a page request for a web page with an advertisement, according to the prior art.

FIG. 2 is a system diagram showing a generalized cookie analysis system in which one or more described embodiments can be implemented.

FIG. 3 is a flow chart showing an example cookie analysis technique, according to one or more described embodiments.

FIG. 4 is a diagram showing example cookies with segment information and user ID information, respectively, according to the prior art.

FIG. 5 is a system diagram showing an example cookie analysis arrangement in which one or more described embodiments can be implemented.

FIG. 6 is a flow chart showing an example cookie analysis technique in which cookies corresponding to objects rendered in a browsing simulator are analyzed, according to one or more described embodiments.

FIG. 7 is a flow chart showing an example cookie analysis technique in an ad server context in which unauthorized cookies are flagged, according to one or more described embodiments.

FIG. 8 is a flow chart showing a detailed example cookie analysis technique, according to one or more described embodiments.

FIG. 9 is a diagram showing a cookie information analyzer/formatter that analyzes and formats cookie information, according to one or more described embodiments.

FIG. 10 is a diagram showing a detailed cookie report that can be generated by a cookie information analyzer/formatter, according to one or more described embodiments.

FIG. 11 illustrates a generalized example of a suitable computing environment in which one or more of the described embodiments may be implemented.

FIG. 12 illustrates a generalized example of a suitable implementation environment in which one or more described embodiments may be implemented.

### DETAILED DESCRIPTION

Techniques and tools are described that relate to analysis of information (e.g., cookies) that has been placed on client computers by other computers on a network. For example, techniques and tools are described for determining whether cookies that have been stored on a computer in response to a particular event (e.g., the rendering of an advertisement in a browser) are authorized or unauthorized. As used herein, the term “cookie” refers to HTTP cookies or other objects (such as local shared objects used by Adobe Flash Player) stored on a client computer that can be used to provide information (e.g., details about the client computer itself, users of the client computer, or how the client computer has been used) to other computers over a network. As used herein, the term “rendering” refers to the processing of source code and/or other data in a browser. The source code and/or other data can represent visual information, such as web pages, advertisements, etc., and can provide functionality such as interactive user interface elements. When rendered by the browser, the source code and/or other data can cause visual information to be displayed in a browser window given the existence of appropriate conditions (e.g., the presence of a display that is operable to receive data corresponding to a rendered page and to display the page). However, rendering does not, in itself, include any actual display of rendered visual information. When rendered by the browser, the source code and/or other data also can cause events to occur (e.g., writing new cookies, or reading or modifying cookie information in existing cookies) that are not visible in a typical browsing session.

In one implementation, a cookie analysis system includes a browsing simulator having a virtual graphical environment. The cookie analysis system can render web pages for a set of several ad creatives downloaded from an ad server (e.g., one page per ad creative). The cookie analysis system identifies cookies that are stored on the proxy client computer in response to the rendering of a particular ad creative. Ad creatives are typically represented as ad creative objects, such as Java objects. Cookie information is provided to a cookie analyzer, which determines whether cookies generated in response to the rendering of a particular ad creative are unauthorized. As used herein, the term “cookie information” refers to information stored in or obtained from a cookie (e.g., a domain with which the cookie is associated, user information, etc.). The output from the cookie analyzer can be used in further processing. For example, the output can be formatted in a report showing details of unauthorized cookies.

Various alternatives to the implementations described herein are possible. For example, techniques described with reference to flowchart diagrams can be altered by changing the ordering of stages shown in the flowcharts, by repeating or omitting certain stages, etc. As another example, although some implementations are described with reference to HTTP cookies, described techniques and tools can be used with other types of information that can be stored on a client computer by a server, such as local shared objects used by applications such as Adobe Flash Player provided by Adobe Systems Inc. As another example, although some implementations are described with reference to systems with specific components (e.g., a cookie analysis system with a browsing simulator), described techniques and tools can be used with other specialized or general-purpose systems, including systems with functionality that is not limited to cookie analysis (e.g., operating systems).

The various techniques, tools and examples described herein can be used in combination or independently. Different embodiments implement one or more of the described techniques and tools.

### I. Cookie Analysis Techniques and Tools

Cookies can be used to provide information to other computers on a network. Some common types of information provided by cookies are user identity information (e.g., a user ID number), browser information (e.g., a browser type and version number), session or state information that allows websites to “remember” aspects of a particular browsing session (e.g., user preferences, account login information, or the contents of an online “shopping cart”), and user behavior information (e.g., a record which websites a user has visited).

Although cookies can provide useful information to many different entities, placing cookies on computers may violate certain policies, and can even result in the theft of commercially valuable data. One scenario in which unauthorized storage of cookies can be a problem involves advertisers and publishers.

By placing cookies on computers of users that visit their websites, publishers are able to acquire valuable information about user behavior. Publishers can then offer advertisers the ability to target certain users who will be more receptive to certain types of advertising. Advertisers also can use cookies of their own to learn about user behavior. For example, tracking cookies can be used to gather data relating to the various websites that a user may visit.

Often, an agreement between a publisher and an advertiser will prohibit the advertiser from placing its own cookies (or particular types of cookies, such as tracking cookies, behavioral targeting cookies, etc.) on the computers of users (e.g., users of the publisher's website who have caused an ad call to be made to the advertiser). However, advertisers or advertising consultants may still place unauthorized cookies on client computers in violation of such agreements, putting valuable user behavior information at risk of being misappropriated by the advertisers or advertising consultants. Therefore, there is a need for techniques and tools for detecting whether cookies are unauthorized (e.g., because they are set by an advertiser in violation of a contract) and reporting this behavior back to a publisher or vertical ad network to allow them to better protect their user data.

Accordingly, techniques and tools are described that relate to analysis of cookie information on a computer. In particular, techniques and tools are described for determining whether cookies that have been stored on a computer in response to a particular event (e.g., the rendering of an advertisement in a browser) are authorized. As used herein, the term “authorized” can be used to refer to any cookie that is associated with a “safe” domain (e.g., from a domain on a “safe list” of domains). The term “authorized” also can be used to refer more generally to cookie objects that are not prohibited (e.g., by an agreement) from being stored on a computer. For example, an authorized cookie and an unauthorized cookie can be associated with the same domain in some situations, such as when the unauthorized cookie violates an agreement while the authorized cookie does not.

### A. OVERVIEW OF BEHAVIORAL TARGETING AND AD NETWORKS

Content providers (or “publishers”) often work with advertisers to help them attract more customers.

Advertisers provide advertisements (e.g., banner ads, pop-up ads) to be displayed when users visit publishers' websites. In some cases, the entity that provides an advertisement for a product may be the same entity that actually sells the advertised product, but often the advertisement comes from a different entity, such as an advertising consultant. As used herein, the term “advertiser” refers to entities that actually sell advertised products, or entities such as advertising consultants or agencies that create or provide advertisements on behalf of others.

On a typical ad-supported web site, publishers provide content (e.g., news articles, images, video, audio, personalized content such as a social networking pages, etc.) to a user via a web page along with advertisements. Advertisements are often presented as images or animations (e.g., in the form of a banner ad that runs above, below, or alongside content on the page being visited by the user, or a pop-up ad that is displayed in a separate area, such as a new browser window). Such an image or animation can be referred to as an “ad creative.” An ad creative can refer to the file containing the actual graphical representation of an online advertisement, or the graphical representation itself. For example, ad creatives can take the form of an image file (e.g., a JPEG image file, or some other image format) containing an image for a banner advertisement.

An ad server can be used to manage the display of ads on websites. An ad server typically provides a management console for the trafficking of any number of ads on a site, with an aim of smooth delivery of ads based on criteria such as delivery goals and financial goals. In a typical scenario, when a user visits a page, a web page server communicates with an ad server, which is controlled by the publisher and provides an advertisement on the page. This can be accomplished by the use of a “tag”—a piece of code on a publisher site that requests information from an outside source. For example, an ad tag can be used to make a call to an ad server for the appropriate ad to serve on a site. The ad server controlled by the publisher is usually not the original source of the ad creative. Instead, the ad creative is usually provided by a server controlled by a different entity, such as an advertising consultant. In order to obtain the appropriate ad creative, the ad server sends a page identifier to an advertiser's server. The page identifier identifies the page (e.g., a page being visited by a user) that originated the ad call. In response, the advertiser sends an appropriate ad creative to the ad server, which then downloads the ad creative to the user's computer.

The effect of advertising can be measured in terms of “reach”—the number of people visiting a website or collection of sites, usually measured in the number of unique visitors. Publishers can be grouped together in ad networks, which can work collectively with the goal of reaching more users. A vertical ad network is a collection of publishers with similar content (e.g. an automotive vertical ad network, a technology vertical ad network). Vertical ad networks can group together an audience with similar interests, which allows more targeted advertising while providing more reach than a single publisher could achieve alone.

Advertisers can employ different advertising strategies, such as contextual advertising and behavioral targeting (BT) advertising. In contextual advertising, advertisements are displayed alongside content that is relevant to the audience an advertiser is trying to reach. An advertisement for car insurance next to a review of a new car is an example of contextual advertising. In BT advertising, advertisements are displayed to a user based on information collected on an individual's behavior. In online advertising, relevant behavior can include a set of actions during a user's browsing that indicates their interests. Such actions can include the pages a user has visited or the searches a user has made. In BT advertising, users can be sorted into segments—sets of users grouped by common behavior. A BT network is a network that uses BT advertising technology to display ads to visitors. A BT network typically includes a collection of publisher sites that have opted into the network.

Publisher sites and vertical ad networks are a source of behavior data that is valuable to advertisers. By tracking users' navigation paths on publishers' sites, publishers are able to segment their users into buckets of behavior that, to an advertiser, is an indicator of whether or not they would be interested in a product.

As an example, a publisher such as an automotive research site could set up rules in order to put users in appropriate BT segments or “buckets” based on their behavior. With cookies, the automotive research site can see if a user has navigated to research pages for a particular make or model of automobile. A user could be assigned to a particular segment or bucket that identifies the user as one who is shopping for a minivan if the user viewed a particular number of (e.g., three or more) minivan-related pages in a given time frame (which is considered to be consistent with the behavior of someone who might be shopping for a new minivan). For example, if User A viewed the vehicle specification pages for two different makes of minivan, and then viewed an overview page for a third make of minivan on the same day, User A could be put into a “minivan-intender” bucket.

With contextual advertising, ad placement can be straightforward. For example, an advertiser wanting an ad for a particular product (e.g., an ad for baby food) to be viewed by users in the “minivan-intender” segment can buy ad space on pages specific to minivans. Later on, however, the same user may visit other websites having nothing to do with minivans. BT advertising allows advertisers to follow the same user to other web sites where the connection to the advertised product is less clear. For example, a publisher in a behavior targeting network can place a cookie on a client computer that associates a user of that computer with a particular BT segment. Once a user has been placed in a BT segment, when the user visits a website in the BT network, advertising can be further tailored to the user based on the segment the user is in, even if the website they are visiting is unrelated to the segment. For example, if a user in a “minivan-intender” segment visits a sports news website in a behavioral targeting network, an advertiser can be alerted to the user's status as a minivan-intender with a cookie, and target the user with a baby food ad.

Under typical agreements between publishers and advertisers, the ability to segment users into behavioral buckets is supposed to be reserved for publishers, which can then sell access to the audience of segmented users to advertisers at a premium. However, advertisers sometimes covertly gather behavior data through the use of their own cookies without the knowledge of publishers. For example, an ad call is made to an advertiser's system to display an ad, and along with that ad call is information (e.g., a page identifier) that describes the page that originated the call. With this information, an advertiser can determine where the ad is targeted on the publisher site. The advertiser is then able to build their own database of web pages on the publisher site visited by users and create their own BT segments. Advertisers can pick up these users later by detecting the presence of their own cookies on users' computers as the users interact with one or more websites. By working in conjunction with a large-scale ad network, advertisers can use unauthorized cookies to select and display targeted advertising to users without paying the premiums to a publisher site.

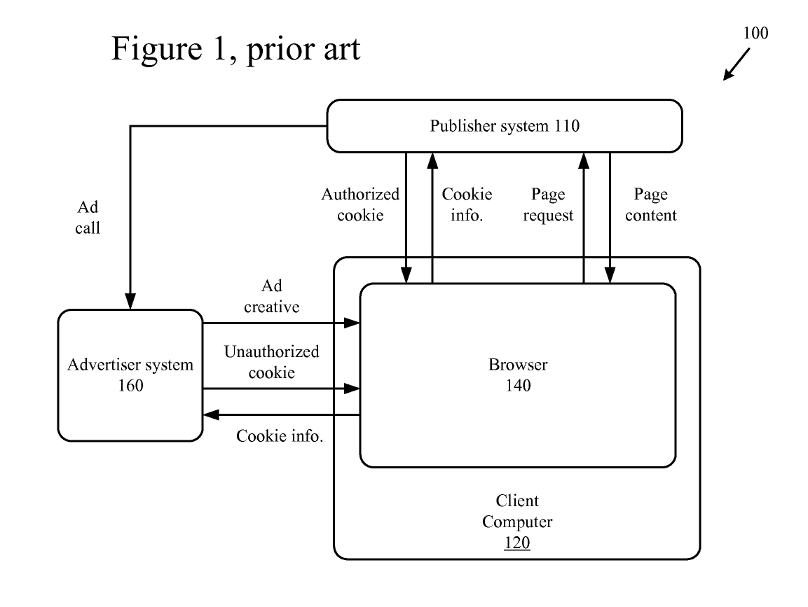

FIG. 1 is a system diagram showing an arrangement 100 in which a client computer 120 sends a page request for a web page with an advertisement. Client computer 120 communicates with a publisher system 110 and an advertiser system 160. In this arrangement, a user of client computer 120 uses browser 140 to navigate to a web page with content provided by publisher system 110, which typically includes one or more server computers. The browser 140 sends a page request to a server in the publisher system 110. The page request can include information such as cookie information, which can be obtained from cookies stored on the client computer 120. For example, the page request can be made in the form of an HTTP GET message, which includes cookie information and a Uniform Resource Locator for the page.

In response to the page request, the publisher system 110 provides page content and initiates the process of providing the advertisement on the requested page by making a call to advertiser system 160 (which typically includes one or more server computers) in order to obtain an ad creative from advertiser system 160. This call can be referred to as an “ad call.” In practice, the publisher system 110 may include an ad server (not pictured) that is under the control of publisher. The ad server can be used to select and provide the ad creative to be displayed in the page requested by the user. The arrow labeled “ad creative” in FIG. 1 shows that the source of the ad creative in this example is the advertiser system 160.

Information provided to advertiser system 160 with the ad call can be used by an advertiser to obtain user behavior data. For example, advertiser system 160 may include functionality for creating BT segments based on information received with ad calls. BT segment information associated with the user also can be stored, for example, in an unauthorized cookie on client computer 120.

### B. OVERVIEW OF COOKIE ANALYSIS TECHNIQUES AND TOOLS

Cookie information can be monitored and analyzed using techniques and tools described herein. For example, cookies associated with a particular event (e.g., the rendering of an ad creative on a web page) can be inspected to determine the domain with which they are associated, and the corresponding domains can be compared with a list of domains that are authorized, or with a list of domains that are not authorized. Described techniques and tools can be utilized by various entities (e.g., a publisher or vertical ad network) to, for example, detect the presence of unauthorized cookies set by an advertiser. Described techniques and tools can be applied to cookie objects such as HTTP cookies or other objects (e.g., local shared objects used by Adobe Flash Player provided by Adobe Systems Inc. (sometimes called “flash cookies” in this art)).

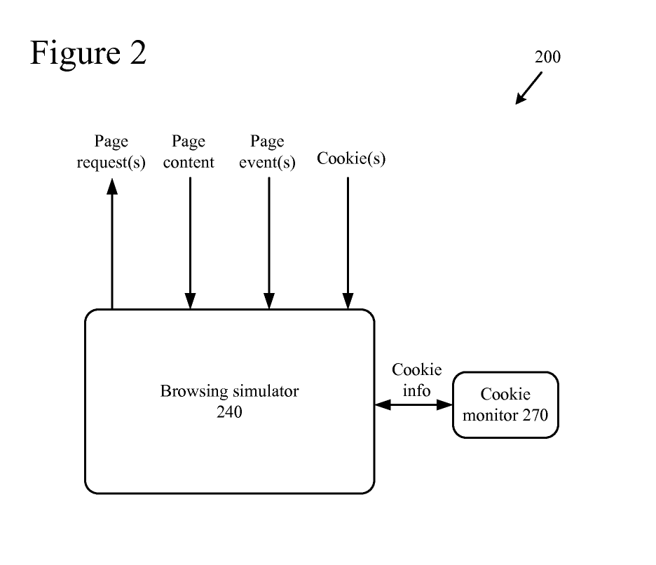

FIG. 2 is a system diagram showing a generalized cookie analysis system 200 in which one or more described embodiments can be implemented. A browsing simulator 240 can automatically generate and send page requests (e.g., to a publisher computer system or vertical ad network) to request pages. Alternatively, page requests can also involve some kind of user input, and need not be fully automatic. In response to the page requests, the browsing simulator 240 receives page content. Browsing simulator 240 displays (or simulates display of) the requested pages based on the received page content and other page events (e.g., the serving of ad creatives, such as banner ad images or animations, with the content). The page events affect how the page is presented to browsing simulator 240. In one scenario, browsing simulator 240 sends page requests to a publisher computer system (not shown) that includes an ad server, and the page events include display or simulated display of ad creatives.

Browsing simulator 240 also receives one or more cookies associated with the page events. For example, an advertiser system (not shown) sends one or more unauthorized cookies to browsing simulator 240. Cookies are monitored (e.g., automatically) by cookie monitor 270 (e.g., to determine whether any cookies being transmitted to browsing simulator 240 are unauthorized). Any cookie provided by any system to browsing simulator 240 can be monitored by cookie monitor 270. Cookie information obtained by cookie monitor 270 can be used in various ways. For example, cookie information can be incorporated into a cookie report that flags unauthorized (or potentially unauthorized) cookies.

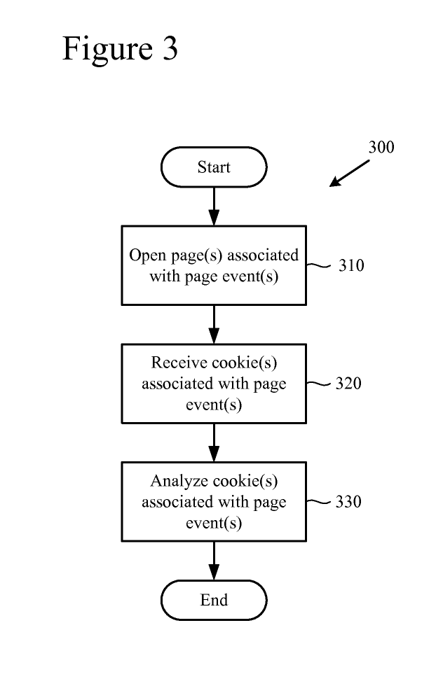

FIG. 3 is a flow chart showing an example cookie analysis technique 300. Technique 300 can be implemented in a system such as cookie analysis system 200 depicted in FIG. 2, or in some other tool. At 310, the cookie analysis system opens (e.g., automatically, in a browsing simulator) one or more pages associated with one or more page events (e.g., the rendering of ad creative objects). For example, the cookie analysis system automatically opens pages in which ad creative objects are rendered as advertisements on the pages. At 320, the cookie analysis system receives cookies associated with the page events. For example, the cookie analysis system receives cookies associated with rendered ad creative objects. At 330, the cookie analysis system analyzes the cookies associated with the page events. For example, the cookie analysis system checks the received cookies to determine the domains associated with the cookies, and compares the domains with a list of authorized domains (a “whitelist” or “safe list”), a list of unauthorized domains (a “blacklist”), or some combination of authorized domains and unauthorized domains. The cookie analysis system also can compare the domains with a list of potentially unauthorized domains. A list of potentially unauthorized domains can include, for example, domains associated with advertisers that are under an agreement with a publisher and are permitted to store only some types of cookies on user computers (e.g., only cookies that cannot be used to track user behavior in violation of the agreement). Results of the cookie analysis can be used in different ways. For example, data obtained by cookie analysis can be formatted in an unauthorized cookie report and/or stored in a database or memory for use in further processing steps.

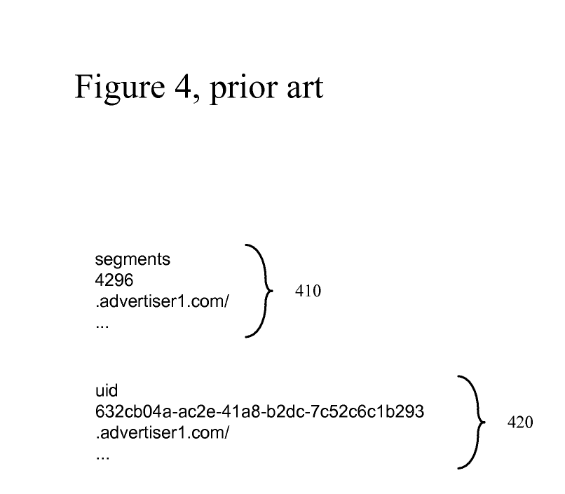

FIG. 4 is a diagram showing example cookies 410, 420 with segment information and user ID information, respectively. Cookies 410, 420 or other cookies can be analyzed by one or more described tools, such as cookie analysis system 200 depicted in FIG. 2, using one or more of the techniques described herein. For example, a cookie analysis system can determine a domain associated with the cookie and compare the domain against a list of unauthorized domains. For domains that may be capable of setting some cookies that are authorized, and some cookies that are not authorized, a cookie analysis system can obtain other information from the cookies 410, 420, to make a determination about whether the cookie is authorized. For example, cookie analysis system could determine that cookie 410 is unauthorized because the name (“segments”) indicates that it is being used for tracking behavior targeting segments, and the string representing the domain (“.advertiser1.com”) does not appear on a safe list.

As used herein, the term “domain” refers to a realm of administrative autonomy, authority, or control on the Internet. Domains can be represented in different ways. For example, domains can be represented with a string containing a partial address (e.g., “.exampledomain.com”), and the partial address can be used to represent an arbitrary number of HTTP addresses or other addresses (e.g., secure HTTP (HTTPS) addresses, file transfer protocol (FTP) addresses, etc.) that end in the same way. For example, “http://www.exampledomain.com” and “https://my.exampledomain.com” could both be represented by the same string (“.exampledomain.com”).

Cookies 410, 420 can be represented and stored in the format shown in FIG. 4, or in some other format. For example, cookies 410, 420 can be stored in the format shown in FIG. 4 in a text file stored on a computer comprising a browsing simulator such as browsing simulator 240 shown in FIG. 2. Cookie 410 includes a string that indicates a name for the cookie (“segments”), a value (“4296”), and a string that indicates a domain (“.advertiser1.com”) with which cookie 410 is associated. To indicate that a user is associated with more than one segment, cookie 410 could be modified to contain several numbers, or replaced with a new cookie that includes several numbers in the value (e.g., “4296 1234”). Cookie 420 includes a string that indicates a name for the cookie (“uid”), a value (“632cb04a-ac2e-41a8-b2dc-7c52c6c1b293”) and a string that indicates a domain (“.advertiser1.com”) with which cookie 420 is associated. The first two lines in cookies 410, 420 can be referred to as name-value or key-value pairs. Cookies 410, 420 also can include other information, such as an expiration date.

### C. EXAMPLES

### Example 1

### Arrangement for Analyzing Cookies Associated with Ad Creatives

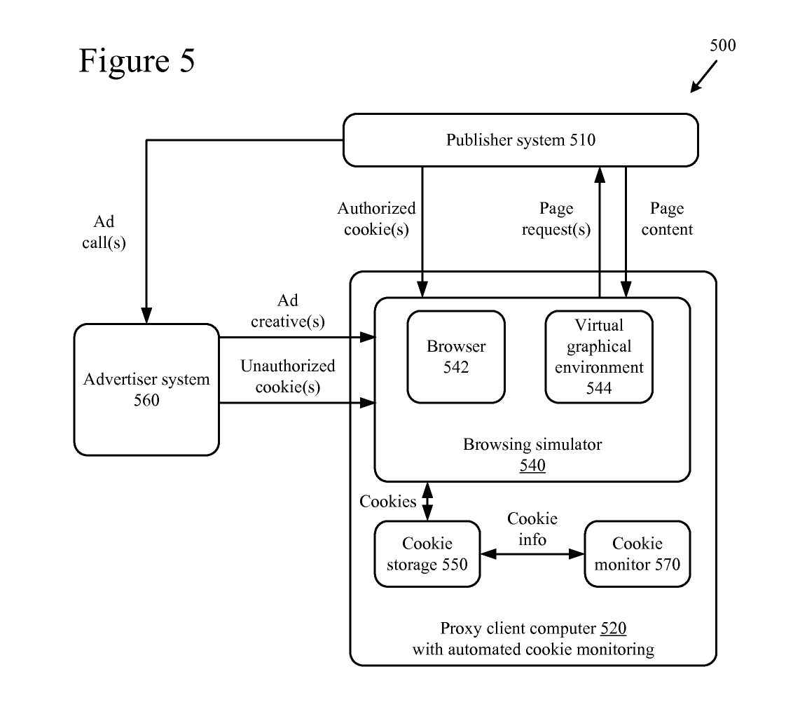

FIG. 5 is a system diagram showing an example arrangement 500 in which one or more described embodiments can be implemented. A proxy client computer 520 with automated cookie monitoring includes a browsing simulator 540. As used herein, “proxy client computer” refers to one or more computing devices that exhibit behavior similar to a computer that is being used by a user in a browsing session (e.g., exchanging information with one or more server computers, receiving cookies, etc.) and may also provide other functionality, such as cookie monitoring.

The browsing simulator 540 includes a browser 542. Browsing simulator 540 can automatically generate and send page requests via the browser 542 to publisher system 510 (which typically includes one or more server computers) to request pages with advertisements. For example, the page requests can be made in the form of an HTTP GET message, which includes cookie information and a URL for the requested page.

In response to the page requests, the publisher system 510 provides page content to the browsing simulator 540. The publisher system 510 also makes ad calls to advertiser system 560 (which typically includes one or more server computers) for advertisements in the requested pages. In practice, the publisher system 510 may include an ad server (not pictured) that is under the control of a publisher. The ad server can be used to select the ad creatives to be displayed in the requested pages. The source of the ad creative in this example is the advertiser system 560.

The browsing simulator 540 also includes a virtual graphical environment 544. The virtual graphical environment 544 allows the browsing simulator 540 to render web pages without displaying them. The rendering of pages in the virtual graphical environment 544 can cause cookies to be sent to the proxy client computer 520.

In the example shown in FIG. 5, advertiser system 560 sends one or more unauthorized cookies to proxy client computer 520 via browsing simulator 540. (In practice, the unauthorized cookies can be set by (or in response to the rendering of) ad creatives, which may be provided to proxy client computer 520 through an ad server controlled by publisher system 510.) Although advertiser system 560 is shown only sending unauthorized cookies, advertiser system 560 can send one or more authorized cookies, one or more unauthorized cookies, a combination of authorized cookies and unauthorized cookies, or no cookies, depending on the content and nature of the ad creative being processed. For example, advertiser system 560 may store an authorized cookie along with an unauthorized cookie configured to obtain behavioral targeting information. The arrangement 500 also can include one or more other advertiser systems (not shown) that provide ad creatives and unauthorized cookies to proxy client computer 520.

In the example shown in FIG. 5, cookies (including any unauthorized cookies) are stored in cookie storage 550, which is monitored and analyzed by cookie monitor 570 to determine whether any cookies being transmitted to proxy client computer 520 are unauthorized. Any cookie provided by any system can be monitored by cookie monitor 570. Cookie information obtained by cookie monitor 570 can be used in various ways. For example, cookie information can be sorted, stored and/or incorporated into a cookie report that flags unauthorized (or potentially unauthorized) cookies. Data output from cookie monitor 570 also can be used in further data processing steps.

Alternatively, the arrangement 500 can be configured in different ways. For example, cookie monitor 570 can be integrated into browsing simulator 540. As another example, cookie monitor 570 can run on one or more computers outside proxy client computer 520. As another example, the arrangement 500 can include additional elements, such as a formatter for formatting output from cookie monitor 570 into cookie reports.

### Example 2

### Analyzing Cookies Associated with Rendered Objects

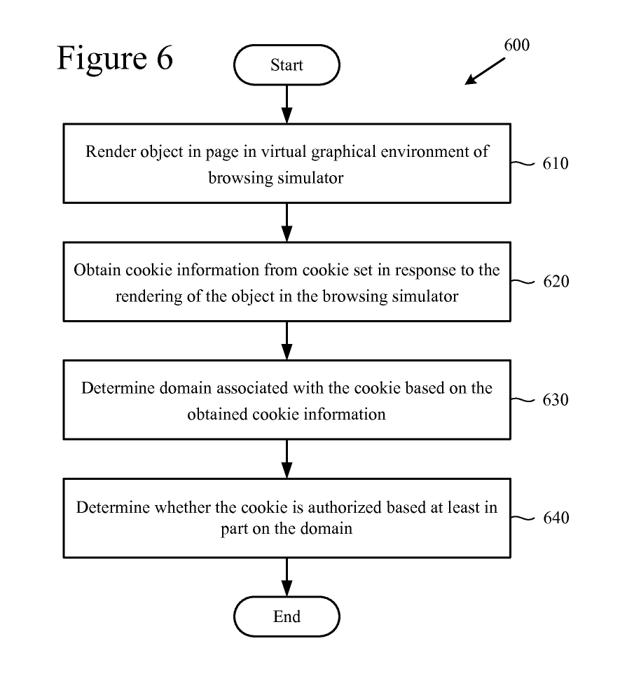

FIG. 6 is a flow chart showing an example cookie analysis technique 600 in which cookies corresponding to objects rendered in a browsing simulator are analyzed. Technique 600 can be implemented in an arrangement such as arrangement 500 depicted in FIG. 5, or in some other arrangement. For example, a cookie analysis system such as proxy client computer 520 (FIG. 5) with automated cookie monitoring functionality can implement the technique 600.

At 610, a cookie analysis system renders a page in a browsing simulator comprising a web browser and a virtual graphical environment. The rendering of the page comprises rendering an object (e.g., an ad creative object) on the page in the virtual graphical environment. At 620, the cookie analysis system obtains cookie information from at least one cookie corresponding to the rendered object that was set in response to the rendering of the object. For example, the cookie analysis system detects and obtains cookie information from a cookie that was stored in a monitored file system location when an ad creative object was rendered in the browsing simulator. At 630, the cookie analysis system determines a domain associated with the cookie based on the cookie information. For example, the cookie analysis system extracts a string of text corresponding to a domain from the cookie information. At 640, the cookie analysis system determines whether the cookie is authorized based at least in part on the domain. For example, the cookie analysis system can compare the domain with a list of authorized domains or with a list of unauthorized domains to determine whether the cookie is authorized.

### Example 3

### Analyzing Cookies in Ad Server Context

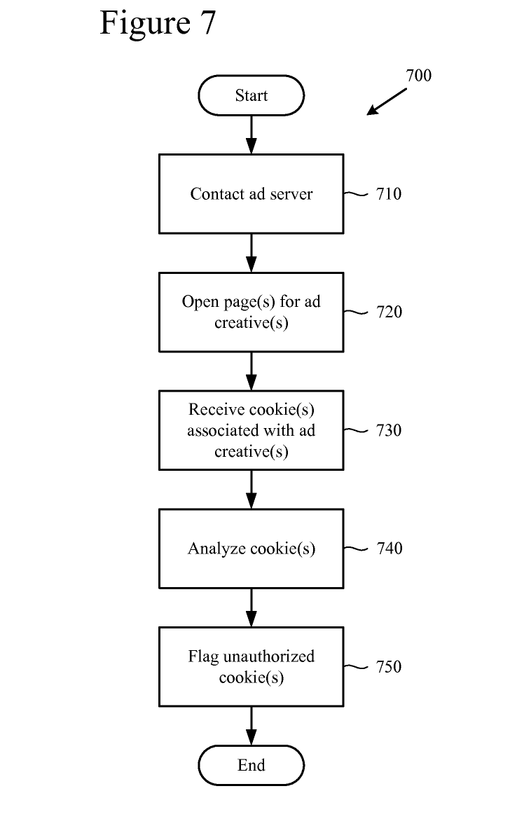

FIG. 7 is a flow chart showing an example cookie analysis technique 700 in an ad server context. Technique 700 can be implemented in an arrangement such as arrangement 500 depicted in FIG. 5, or in some other arrangement. For example, a cookie analysis system such as proxy client computer 520 (FIG. 5) with automated cookie monitoring functionality can implement the technique 700.

At 710, the cookie analysis system first contacts an ad server (e.g., an ad server used by a publisher or vertical ad network). For example, the cookie analysis system contacts an ad server capable of serving a set of several ads on web pages. At 720, the cookie analysis system opens a page (e.g., automatically) for each of one or more ad creatives. For example, the cookie analysis system goes through each ad creative object in an ad creative library on the ad server one at a time, and renders a separate page in a browsing simulator for each ad creative object.

At 730, the cookie analysis system receives cookies associated with the ad creatives. For example, when an advertiser receives an ad call from a publisher requesting an ad creative, the advertiser may send an unauthorized cookie when it sends the ad creative. Cookies received by the cookie analysis tool can be saved in a separate file. Received cookies will typically include a key-value or name-value pair (e.g., a name for the cookie such as “User ID” and a value (such as an alphanumeric value) associated with the name), along with other information, such as the domain the cookie is associated with. At 740, the cookie analysis system analyzes the received cookies. For example, after going through each creative in the creative library, the cookie analysis system examines each cookie and compares the set of domains against a list of known domains (a “safe list”). At 750, the cookie analysis system flags unauthorized cookies. For example, cookies associated with domains that are not on a safe list are flagged as unauthorized and written to a log file. Data in the log file can be processed further and/or stored (e.g., for later follow-up and investigation).

### Example 4

### Cookie Analysis System on Headless Server

In this example, a detailed implementation of a cookie analysis system is described. The cookie analysis system in this detailed implementation is designed to run on a computer that is not connected to a display monitor or any user input device. Such a computer that operates as a server can be referred to as a “headless” server. The cookie analysis system includes a browsing simulator with a virtual graphical environment. The browsing simulator with the virtual graphical environment can provide browser functionality without displaying a graphical user interface or any other visual interface. In this way, the cookie analysis system can render web pages without displaying them, and does not require user input when rendering the web pages. Eliminating the need for user input allows the cookie analysis system to render large numbers of web pages, and cookie information can be obtained from those web pages.

For example, a cookie analysis system runs on a headless server with 1 GB RAM and a 1 GB hard disk running a on a Linux operating system, a Mozilla Firefox web browser and a virtual graphical environment. The virtual graphical environment is an Xvfb virtual frame buffer that performs graphical operations in memory, without display output. The Xvfb virtual frame buffer simulates a standard X11 server, accepting and responding to application programming interface (API) calls that a client makes to it, but forgoing the processing that is typically involved in actually displaying the results of the calls. This detailed implementation can be implemented on other computer systems, as well, such as systems having different storage capacities or memory sizes, or computer systems running different operating systems. For example, this detailed implementation can be implemented in other Unix-like systems, such as computer systems running Ubuntu Linux provided by Canonical Ltd., Red Hat Linux provided by Red Hat, Inc., or Mac OSX provided by Apple Inc.

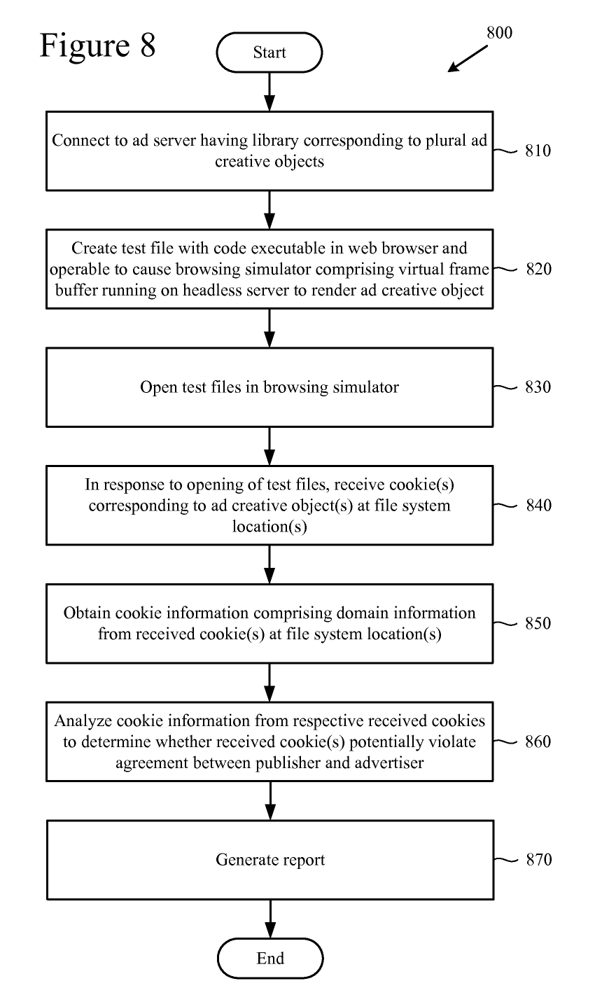

FIG. 8 is a flow chart showing a detailed cookie analysis technique 800. At 810, the cookie analysis system connects to an ad server having a library corresponding to several ad creative objects. For example, the cookie analysis system obtains ad creatives from an ad server by connecting to the API of the ad server. In this example, the ad creatives are represented by a collection of objects (e.g., Java objects) in memory of the computer. The cookie analysis system loops through each of the objects representing the ad creatives, calls a predefined set of functions on each object, and stores the return values in variables that are used to create, at 820, a test file (e.g., a HyperText Markup Language (HTML) file) for each object. Available functions are defined by an API library that creates the object. Alternatively, the cookie analysis system can handle ad creative objects in some other way. For example, different functions can be called for different objects or for different types of objects, return values can be used in different ways, etc.

Each test file contains the code necessary to render the corresponding ad creative in the web browser. The virtual graphical environment (in this case, the Xvfb virtual frame buffer) allows the cookie analysis system to render pages for each test file and ad creative as it normally would on a computer with a display, but without displaying the rendered pages. The virtual graphical environment allows rendering of pages and ad creatives that use current web technologies, such as scripting language functionality (e.g., JavaScript functionality), markup language functionality (e.g., XML), multimedia features (e.g., animations for Adobe Flash Player provided by Adobe Systems Inc.) and combinations thereof.

At 830, the cookie analysis system opens each test file in the browsing simulator. For example, the cookie analysis system processes the source code of the test files and renders ad creative objects. At 840, one or more cookies corresponding to the ad creative objects are received at one or more file system locations in response to the opening of the test files. For example, the cookie analysis system runs a script that opens each test file in the web browser and monitors cookies that are written by the test file. For cookie monitoring, the cookie analysis system monitors a file system location where cookies are stored and notes the cookies that are stored there for each test file. In this example, the cookie analysis system monitors cookies by running a script in the Perl programming language after the rendering of each test file. At 850, the cookie analysis system obtains cookie information from the received cookies. In this example, the script opens a cookie file at an appropriate file system location and parses this cookie file using regular expressions to isolate the pertinent information about what cookies were set, and where they originated. For example, a regular expression can be used to extract domain information (e.g., a string of the form “.exampledomain.com”) from the cookie file. At 860, the cookie analysis system analyzes the cookie information for the respective received cookies to determine whether any of the received cookies potentially violate an agreement between a publisher and an advertiser. For example, the cookie analysis system can compare domain information with lists of authorized, unauthorized, or potentially unauthorized domains. The cookie analysis system can make a determination as to whether a cookie is authorized under the agreement based on other information (e.g., whether the cookie was set in response to the opening of a test file corresponding to a particular ad creative object) in addition to domain information. For example, the cookie analysis system can distinguish between authorized cookies and unauthorized cookies that originate from the same domain (e.g., by analyzing cookie information that indicates a purpose, such as behavioral targeting, for the cookie). Monitoring of cookies that are set in response to the rendering of particular ad creatives can help to distinguish those cookies from other cookies (e.g., cookies from the same domain) that may exist on a client computer for some other reason.

When each test file has been tested, the cookie analysis system can create a report (e.g., a report that summarizes the cookie information along with other information relating to advertisements associated with the cookies). For example, at 870, the cookie analysis system generates a report based on the analysis of the cookie information that indicates, for example, which cookies were set by the test file for each ad creative object, and whether a domain associated with the corresponding ad creative is authorized to set cookies under the agreement.

### Example 5

### Cookie Information Analyzer/Formatter

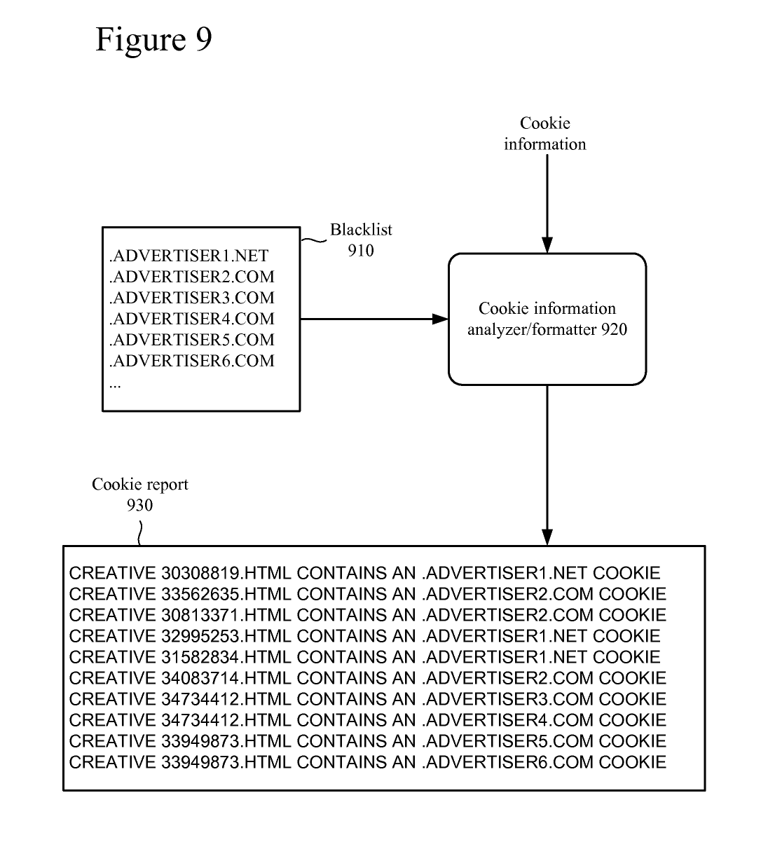

FIG. 9 is a diagram showing cookie information analyzer/formatter 920 that analyzes and formats cookie information. The analyzer formatter can be implemented in a cookie analysis system such as proxy client computer 520 or in some other cookie analysis system. The analyzer/formatter 920 compares cookie information (e.g., domains associated with cookies) with a “blacklist” 910 containing information (e.g., strings representing partial web addresses) that identifies domains that are not authorized to set cookies (e.g., because they are bound by an agreement with a publisher not to set cookies). For example, the analyzer/formatter 920 extracts a string representing a domain in a cookie, and compares the extracted string with the domains represented in the blacklist 910 to determine whether the cookies are authorized. The analyzer/formatter 920 then creates a report that flags cookies associated with domains from the blacklist 910 as unauthorized. In this example, the analyzer/formatter 920 creates report 930 which indicates “blacklisted” (unauthorized) cookies and, for each blacklisted cookie, an identifier for the ad creative that spawned it. The report 930 shows that one ad creative (e.g., “33949873.html”) can set more than one cookie, and that the cookies set by each creative can be associated with more than one domain. Alternatively, information shown in report 930 can be represented in some other form (e.g., a database or software object) and/or used in further processing steps. As another alternative, more or fewer sections can be included in the report 930, and the included sections can include more or fewer types of information, in any combination.

### Example 6

### Detailed Cookie Report

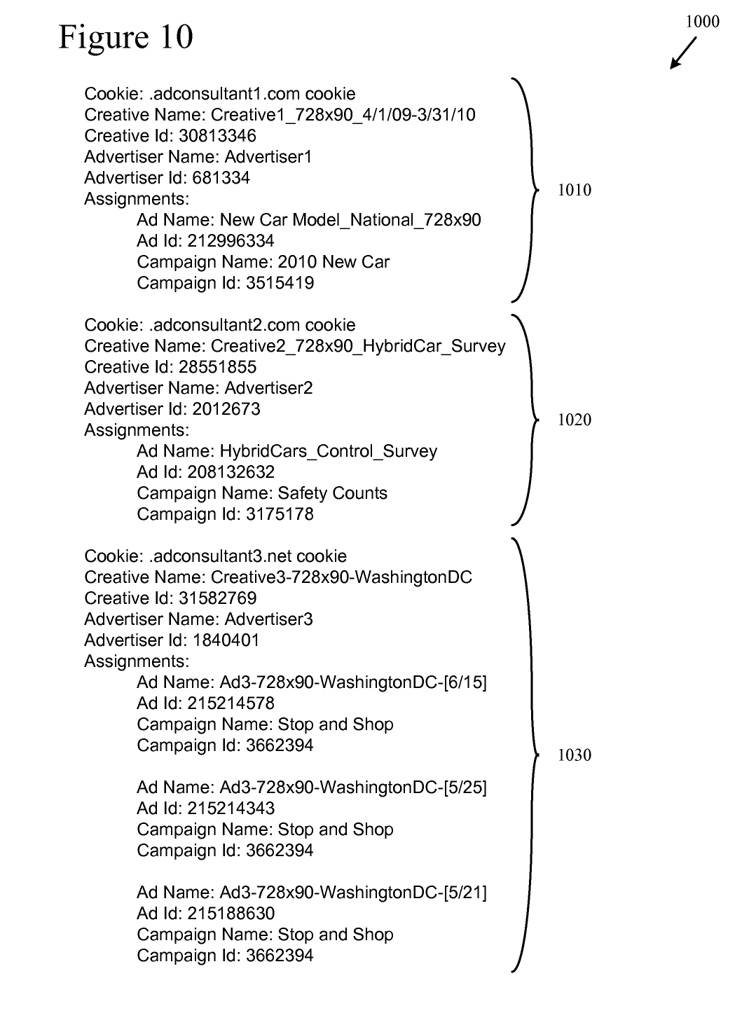

FIG. 10 is a diagram showing a more detailed cookie report 1000. A cookie report in the format depicted in FIG. 10 can be generated by cookie information analyzer/formatter 920 or by some other tool. In this example format, a report section (e.g., section 1010, 1020, or 1030) is provided for each cookie. Each section includes a name for the cookie, a name and ID number for the creative that set the cookie, a name and ID number for the advertiser that provided the ad creative, and a list of one more assignments. The assignments indicate advertisements in which the ad creative is used. For each assignment, an ad name, ad ID number, campaign name and campaign ID number are provided. The report 1000 shows that one ad creative (e.g., the ad creative associated with report section 1030) can be used in more than one advertisement. Alternatively, information shown in report 1000 can be represented in some other form (e.g., a database or software object) and/or used in further processing steps. As another alternative, more or fewer sections can be included in the report 1000, and the included sections can include more or fewer types of information, in any combination.

### II. Extensions and Alternative Implementations

Various alternatives to the examples described herein are possible.

In described implementations, a cookie analysis system monitors a file system location to acquire information about cookies. However, file system locations monitored by cookie analysis systems can vary depending on factors such as the type of cookies to be monitored and the browser that is being used. For example, local shared objects (also known as Flash cookies) are typically stored in a common location (which can vary depending on operating system), regardless of the browser that is being used. However, different browsers also can store cookies (e.g., HTTP cookies) in locations that are specific to the individual browser. Described techniques and tools can be used to analyze cookies in any file system or file location.

The file size of cookies being monitored can vary (e.g., depending on the amount of information in the cookie, or the type of cookie). For example, local shared objects can be 100 kb or more, with a default size of 100 kb. For other cookies (e.g., HTTP cookies), file sizes are much smaller (e.g., 4 kb or less). Described techniques and tools can be used to analyze cookies of any size, in any format.

### III. Example Computing Environment

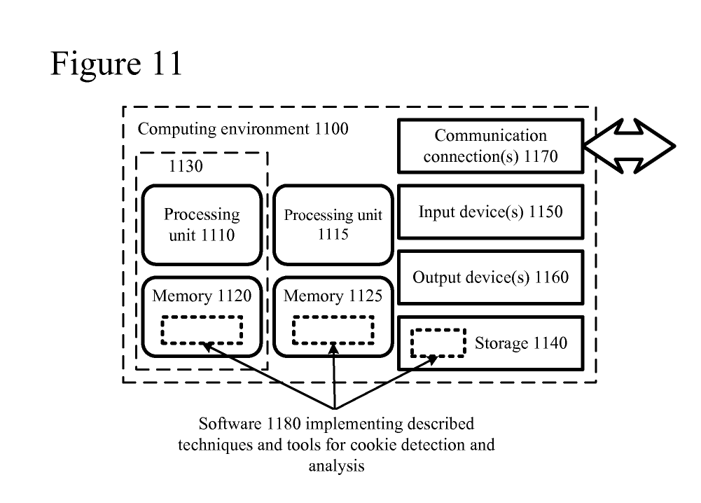

FIG. 11 illustrates a generalized example of a suitable computing environment 1100 in which one or more of the described embodiments may be implemented. The computing environment 1100 is not intended to suggest any limitation as to scope of use or functionality, as the techniques and tools described herein may be implemented in diverse general-purpose or special-purpose computing environments.

With reference to FIG. 11, the computing environment 1100 includes at least one processing unit (e.g., a CPU) 1110 and associated memory 1120. In FIG. 11, this most basic configuration 1130 is included within a dashed line. The processing unit 1110 executes computer-executable instructions and may be a real or a virtual processor. In a multi-processing system, multiple processing units execute computer-executable instructions to increase processing power. FIG. 11 shows a second processing unit 1115 (e.g., a GPU or other co-processing unit) and associated memory 1125, which can be used for video acceleration or other processing. The memory 1120, 1125 may be volatile memory (e.g., registers, cache, RAM), non-volatile memory (e.g., ROM, EEPROM, flash memory, etc.), or some combination of the two. The memory 1120, 1125 stores software 1180 for implementing a system with one or more of the described techniques and tools.

A computing environment may have additional features. For example, the computing environment 1100 includes storage 1140, one or more input devices 1150, one or more output devices 1160, and one or more communication connections 1170. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, DVDs, memory cards, or any other medium which can be used to store information and which can be accessed within the computing environment 1100. The storage 1140 stores instructions for the software 1180 implementing described techniques and tools.

The input device(s) 1150 may be a touch input device such as a keyboard, mouse, pen, trackball or touchscreen, an audio input device such as a microphone, a scanning device, a digital camera, or another device that provides input to the computing environment 1100. For video, the input device(s) 1150 may be a video card, TV tuner card, or similar device that accepts video input in analog or digital form, or a CD-ROM or CD-RW that reads video samples into the computing environment 1100. The output device(s) 1160 may be a display, printer, speaker, CD-writer, or another device that provides output from the computing environment 1100. Some devices, such as touchscreens, may have both input and output capabilities. Alternatively, as in a headless server configuration, input devices and output devices can be omitted.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RE, infrared, acoustic, or other carrier.

The techniques and tools can be described in the general context of computer-readable media. Computer-readable media are any available media that can be accessed within a computing environment. By way of example, and not limitation, with the computing environment 1100, computer-readable media include memory 1120, 1125, storage 1140, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “check” and “determine” to describe computer operations in a computing environment. These terms are high-level abstractions for operations performed by a computer, and should not be confused with acts performed by a human being. The actual computer operations corresponding to these terms vary depending on implementation.

### IV. Example Implementation Environment

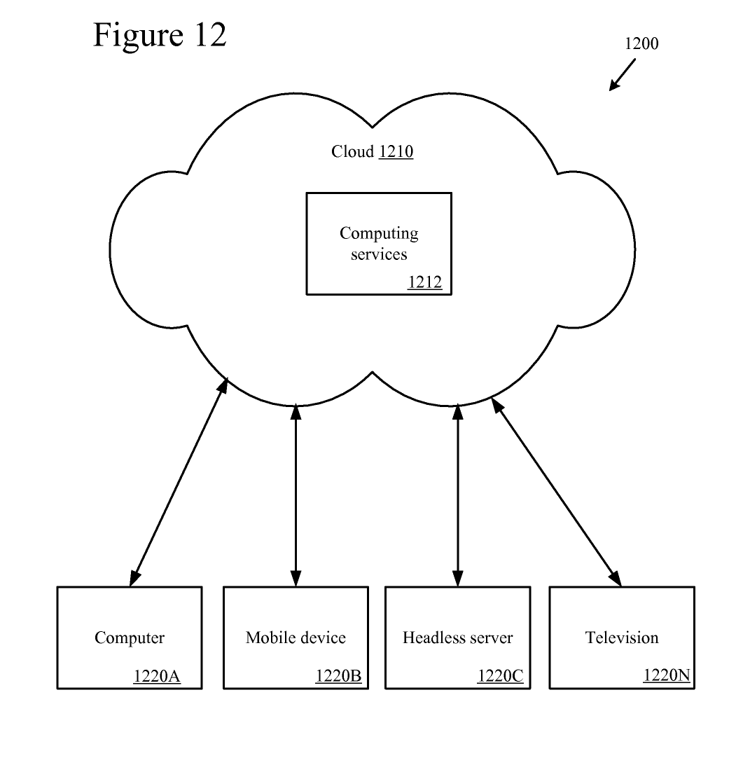

FIG. 12 illustrates a generalized example of a suitable implementation environment 1200 in which described embodiments, techniques, and technologies may be implemented. In general, FIG. 12 shows aspects of a cloud computing environment 1200. The cloud computing environment 1200 can be used in different ways to accomplish computing tasks. For example, with reference to described techniques and tools for cookie analysis, some tasks, such as monitoring cookies set on a client computer, can be performed on a local computing device, while other tasks, such as generation of HTML test files, or archiving results of page testing, can be performed elsewhere in the cloud.

In example environment 1200, various types of services (e.g., computing services 1212) are provided by a cloud 1210. For example, the cloud 1210 can comprise a collection of computing devices, which may be located centrally or distributed, that provide cloud-based services to various types of users and devices connected via a network such as the Internet.

In example environment 1200, the cloud 1210 provides services for connected devices with a variety of screen capabilities 1220A-N. Connected device 1220A represents a device with a mid-sized screen. For example, connected device 1220A could be a personal computer such as desktop computer, laptop, notebook, netbook, or the like. Connected device 1220B represents a device with a small-sized screen. For example, connected device 1220B could be a mobile phone, smart phone, personal digital assistant, tablet computer, and the like. Connected device 1220C represents a device without a screen, such as a headless server. Connected device 1220N represents a device with a large screen. For example, connected device 1220N could be a television (e.g., a smart television) or another device connected to a television or projector screen (e.g., a set-top box or gaming console).

A variety of services can be provided by the cloud 1210 through one or more service providers (not shown). For example, the cloud 1210 can provide services related to mobile computing to one or more of the various connected devices 1220A-N. Cloud services can be customized to the screen size, display capability, or other functionality of the particular connected device (e.g., connected devices 1220A-N). For example, cloud services can be customized for mobile devices by taking into account the screen size, input devices, and communication bandwidth limitations typically associated with mobile devices.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-executed method comprising:
rendering a page in a browsing simulator comprising a web browser and a virtual graphical environment, wherein the rendering of the page comprises rendering an object on the page in the virtual graphical environment;
obtaining cookie information from a first cookie, the first cookie set in response to the rendering of the object in the browsing simulator;
determining a domain associated with the first cookie based on the cookie information; and
determining whether the first cookie is authorized based at least in part on the domain.

2. The method of claim 1 wherein the object comprises an ad creative object.

3. The method of claim 1 wherein the virtual graphical environment comprises a virtual frame buffer, and wherein rendering the page comprises rendering the page in the virtual frame buffer without displaying the page.

4. The method of claim 1 wherein rendering the page comprises processing markup language source code.

5. The method of claim 4 wherein rendering the page further comprises processing scripting language source code.

6. The method of claim 1 wherein determining the domain comprises extracting a string of text information representing the domain from the cookie information.

7. The method of claim 6 wherein the extracting comprises applying a regular expression to the cookie information.

8. The method of claim 1, wherein determining whether the first cookie is authorized comprises:
comparing the domain with a list of domains.

9. The method of claim 8, wherein the list of domains is a list of authorized domains.

10. The method of claim 9, wherein determining whether the first cookie is authorized further comprises:
identifying a match for the domain in the list of authorized domains; and
indicating that the first cookie is authorized based on the identifying.

11. The method of claim 9, wherein determining whether the first cookie is authorized further comprises:
determining that no match for the domain is present in the list of authorized domains; and
indicating that the first cookie is unauthorized.

12. The method of claim 9, wherein determining whether the first cookie is authorized further comprises:
determining that no match for the domain is present in the list of authorized domains; and
indicating that the first cookie is potentially unauthorized.

13. The method of claim 8, wherein the list of domains is a list of unauthorized domains.

14. The method of claim 13, wherein determining whether the first cookie is authorized further comprises:
identifying a match for the domain in the list of unauthorized domains; and
indicating that the first cookie is unauthorized based on the identifying.

15. The method of claim 13, wherein determining whether the first cookie is authorized further comprises:
identifying a match for the domain in the list of unauthorized domains; and
indicating that the first cookie is potentially unauthorized based on the identifying.

16. The method of claim 13, wherein determining whether the first cookie is authorized further comprises:
determining that no match for the domain is present in the list of unauthorized domains; and
indicating that the first cookie is authorized.

17. The method of claim 8, wherein the list of domains is a list of potentially unauthorized domains.

18. The method of claim 1 further comprising:
obtaining cookie information from a second cookie set in response to the rendering of a second object in the browsing simulator;
determining that a domain associated with the second cookie is the same as the domain associated with the first cookie; and
determining that one of the two cookies is authorized while the other cookie is not authorized.

19. The method of claim 1 wherein the first cookie comprises an HTTP cookie.

20. The method of claim 1 wherein the first cookie comprises a local shared object.

21. The method of claim 1 wherein the browsing simulator runs on a headless server.

22. The method of claim 1 wherein the steps of rendering the page, obtaining the cookie information, determining the domain and determining whether the first cookie is authorized are performed automatically.

23. A computing device comprising:
one or more processors; and
one or more computer readable storage media having stored thereon computer-executable instructions for performing a method comprising:
contacting an ad server having a library of plural ad creative objects;
opening a test page in a browsing simulator for each of the plural ad creative objects;
receiving one or more cookies corresponding to the plural ad creative objects;
analyzing the received cookies; and
flagging one or more of the received cookies as unauthorized cookies based on the analyzing.

24. The computing device of claim 23 wherein the browsing simulator comprises a web browser and a virtual frame buffer.

25. One or more computer-readable media having computer-executable instructions stored thereon, the computer-executable instructions capable of causing a computer to perform a method comprising:
connecting to an ad server having stored thereon a library corresponding to plural ad creative objects;
creating a test file for each of the plural ad creative objects, each test file comprising source code that is executable in a web browser and is operable to cause a browsing simulator running on a headless server to render the corresponding ad creative object, the browsing simulator comprising a virtual frame buffer;
opening the test files in the browsing simulator;
in response to the opening of the test files, receiving one or more cookies at one or more file system locations, the one or more cookies each corresponding to one of the plural ad creative objects;
obtaining cookie information from the received cookies, the cookie information comprising domain information for the received cookies;
analyzing cookie information for the respective received cookies to determine whether any of the received cookies potentially violates an agreement between a publisher and an advertiser; and
generating a report based on the analyzing.

26. The computer-readable media of claim 25 wherein the report comprises:
a cookie name for each received cookie;
an identifier for the ad creative object that caused the respective received cookie to be set;
an identifier for an advertiser that provided the ad creative object; and
an identifier for an advertisement in which the ad creative object is used.
